(19) United States
(12) Patent Application Publication
(10) Pub. No.: US 2014/0000734 A1
(43) Pub. Date: Jan. 2, 2014

(54) FUEL DELIVERY PIPES AND METHODS OF MANUFACTURING THE SAME

(71) Applicant: AISAN KOGYO KABUSHIKI KAISHA, Obu-shi (JP)

(72) Inventors: Kensuke NIWA, Nagoya-shi (JP); Masaharu NAGASAKA, Hekinan-shi (JP)

(21) Appl. No.: 13/931,712

(22) Filed: Jun. 28, 2013

(30) Foreign Application Priority Data
Jun. 29, 2012 (JP) 2012-146863

(51) Int. Cl. F16L 41/02; B29D 23/00

(52) U.S. Cl. CPC F16L 41/02; B29D 23/00
USPC 137/561 A; 264/318

(57) ABSTRACT

A fuel delivery pipe may be designed such that, during a molding process of the fuel delivery pipe using a mold, a pressure of a molten resin for molding the fuel delivery pipe is applied to a main pipe portion core used for molding a main pipe portion of the fuel delivery pipe, so that the main pipe portion core is pressed against distribution pipe portion cores used for molding distribution pipe portions of the fuel delivery pipe.

This application claims priority to Japanese patent application serial number 2012-146863, the contents of which are incorporated herein by reference.

### BACKGROUND OF THE INVENTION

1. Field of the Invention

Embodiments of the present invention relate to resin fuel delivery pipes made of resin and configured to distribute fuel to cylinders of an internal combustion engine. More specifically, the embodiments relate to resin fuel delivery pipes in which the central axis of a main pipe portion intersects with distribution pipe portions while the central axis of the main pipe portion is offset from the central axes of the distribution pipe portions. The embodiments also relate to methods of manufacturing the resin fuel delivery pipes.

2. Description of the Related Art

Automobiles may have internal combustion engines serving as drive sources. Fuel may be supplied to the internal combustion engine from a fuel tank. The internal combustion engine may have a plurality of, for example, four, cylinders. The fuel from the fuel tank may be distributed to each of the cylinders. To this end, the internal combustion engine may be provided with a fuel delivery pipe for distributing fuel to each of the cylinders (see, for example, Japanese Laid-Open Patent Publication No. 2000-73909). The fuel delivery pipe may include a main pipe portion through which the fuel is supplied from the fuel tank, and a plurality of distribution pipe portions for distributing the fuel to the cylinders from this main pipe portion. The main pipe portion may be formed as a hollow pipe extending along a straight line. Each of the distribution pipe portions may be opened in a direction orthogonal to the direction in which the main pipe portion extends. In this way, the fuel delivery pipe is formed by one main pipe portion and a plurality of distribution pipe portions, while these conduit lines are configured as hollow conduit lines communicating with each other. This fuel delivery pipe may be manufactured through an injection molding process of resin.

As stated above, the one main pipe portion and the plurality of distribution pipe portions are formed as hollow conduit lines communicating with each other. For this reason, a core of a mold for molding the main pipe portion (hereinafter referred to as the main pipe portion core) and cores of the mold for molding the distribution pipe portions (hereinafter referred to as distribution pipe portion cores) are arranged so as to intersect each other while they are in contact with each other. On the other hand, the central axis of the main pipe portion and the central axis of each distribution pipe portion may be offset so as to be displaced from each other. This is dependent on a space in which the fuel delivery pipe is to be installed. In such a case, the central axis of the main pipe portion core and the central axis of each distribution pipe portion core may be arranged so as to be offset from each other without intersecting each other. Therefore, the abutment force with which each distribution pipe portion core abuts the main pipe portion core may be oriented in a direction offset from the central axis of the main pipe portion core.

Then, depending upon the state in which the molten resin is injected into the mold, insufficient contact may occur between the main pipe portion core and the distribution pipe portion cores. More specifically, when the injected molten resin flows to apply pressure to separate the main pipe portion core and the distribution pipe portion cores from each other, the contact between the main pipe portion core and the distribution pipe portion cores may become insufficient. Hence, a part of the molten resin may enter between the main pipe portion core and the distribution pipe portion cores. This can result in the generation of molding resin burrs between them. When such burrs are generated, it is necessary to perform the operation of removing the burrs, which makes the manufacturing operation rather troublesome.

Therefore, there has been a need in the art for minimizing the generation of burrs when resin fuel delivery pipes are molded.

### SUMMARY OF THE INVENTION

In one aspect according to the present teachings, a fuel delivery pipe may be designed such that a mold is used in a molding process of the fuel delivery pipe. In this process a pressure of a molten resin for molding the fuel delivery pipe is applied to a main pipe portion core used for molding a main pipe portion of the fuel delivery pipe. This results such that the main pipe portion core is pressed against distribution pipe portion cores used for molding distribution pipe portions of the fuel delivery pipe.

### BRIEF DESCRIPTION OF THE DRAWINGS

FIG. 1 is a left-hand side view of a fuel delivery pipe according to an embodiment of the present invention;

FIG. 2 is a bottom view of the fuel delivery pipe of FIG. 1;

FIG. 3 is a sectional view taken along line III-III of FIG. 1;

FIGS. 4(a) and 4(b) are sectional views showing modifications of a rib shown in FIG. 3;

FIG. 5 is a sectional view, corresponding to FIG. 3, of a mold;

FIG. 6 is a sectional view, corresponding to FIG. 1, of the mold; and

FIGS. 7(a) and 7(b) are diagrams illustrating how molten resin flows in a mold shown in FIG. 6.

### DESCRIPTION OF THE PREFERRED EMBODIMENTS

Each of the additional features and teachings disclosed above and below may be utilized separately or in conjunction with other features and teachings to provide improved fuel delivery pipes and methods of manufacturing such fuel delivery pipes. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teachings.

In one embodiment, a fuel delivery pipe may include a main pipe portion configured to receive a supply of fuel from a fuel storage device. It may also include a plurality of distribution pipe portions communicating with the main pipe portion via respective communication holes. The plurality of distribution pipe portions may be configured to distribute fuel from the main pipe portion to respective engine cylinders. The main pipe portion and the plurality of distribution pipe portions may be made of resin and may be integrated together. The main pipe portion may have a first central axis and may extend along the first central axis. Each of the distribution pipe portions may have a second central axis. Each of the distribution pipe portions may extend along the second central axis. Each of the distribution pipe portions may intersect with the main pipe portion, with the second central axis of each of the distribution pipe portions being offset from the first central axis of the main pipe portion. The main pipe portion may include a rib forming portion having a rib projecting from at least one of an inner peripheral surface or an outer peripheral surface of the main pipe portion and extending along an extending direction of the main pipe portion. The rib forming portion may further include an inner peripheral portion disposed at the inner peripheral surface of the main pipe portion at a position in point symmetry. This point of symmetry may occur with respect to the first central axis and with the communication holes.

With this arrangement, during a molding process of the fuel delivery pipe, a molten resin may easily flow into a space in the mold for molding the rib forming portion. In other words, the rib forming portion may be used for promoting the flow of the molten resin. The molten resin flowing into the space for molding the rib forming portion may apply pressure to press a mold part (for example, a main pipe portion core) for molding the main pipe portion against a mold part (distribution pipe portion cores) for molding the distribution pipe portions. Therefore, a contact force (abutment force) between these mold parts, which may be positioned on opposite sides, can be enhanced, so that it is possible to enhance the abutment force with which the mold parts contact each other. Hence, the molten resin may be prevented from entering potential clearances between the mold parts. As a result, it possible to minimize the generation of burrs of the molding resin at the communication holes where the main pipe portion communicates with the distribution pipe portions.

The rib of the rib forming portion may include at least one of a first rib and or a second rib. The first rib may project inward from the inner peripheral surface of the main pipe portion. The second rib may project outward from the outer peripheral surface of the main pipe portion.

In another embodiment, a method of manufacturing a fuel delivery pipe may include providing a mold having a main pipe portion core and a plurality of distribution pipe portion cores. The main pipe portion core may be used for molding the main pipe portion, and the distribution pipe portion cores may be used for molding the distribution pipe portions. The distribution pipe portion cores may contact the main pipe portion core at contact regions. These contact regions may be the communication holes communicating with each other and locked between the distribution pipe portions and the main pipe portion are molded. The method may further include providing a flow promoting space within the mold at a position in point symmetry. This point symmetry may lie with respect to the first central axis of the man pipe portion core and the communication holes for facilitating flow of a molten resin into the flow promoting space. The method may further include injecting a molten resin into the mold to form the fuel delivery pipe. The fuel delivery pipe may have the main pipe portion and the distribution pipe portions integrated with the main pipe portion.

Therefore, the molten resin may preferentially flow into the flow promoting space for applying pressure to press the main pipe portion core against the distribution pipe portion cores. Therefore, a contact force between the main pipe portion core and the distribution pipe portion cores may be enhanced to minimize the generation of burrs of the molding resin at the communication holes.

The mold may further include a resin injection port, through which a molten resin is injected into the mold, and the resin injection port may be opened at the flow promoting space of the mold. Therefore, the molten resin supplied into the resin injection port may first enter the flow promoting space, so that it is possible to ensure that the molten resin preferentially flows into the flow promoting space.

The resin injection port may be directed toward the first central axis. With this arrangement, the force of the molten resin flowing into the flow promoting space via the resin injection port may be applied to the main pipe portion core to increase the contact force between the main pipe portion core and the distribution pipe portion cores.

The resin injection port may be disposed proximal to a part of the mold for forming an opening of the fuel delivery pipe, where the main pipe portion core is supported. This arrangement may be advantageous in a case where the main pipe portion core is supported in a cantilever fashion by a clamp mechanism. Such a clamp mechanism may be disposed proximal to the part of the mold for forming the opening of the fuel delivery pipe.

In another embodiment, a method of manufacturing a fuel delivery pipe may include providing a mold for molding the fuel delivery pipe and injecting a molten resin into the mold. Pressure of the molten resin can applied to a main pipe portion core to press the main pipe portion core against distribution pipe portions at contact regions.

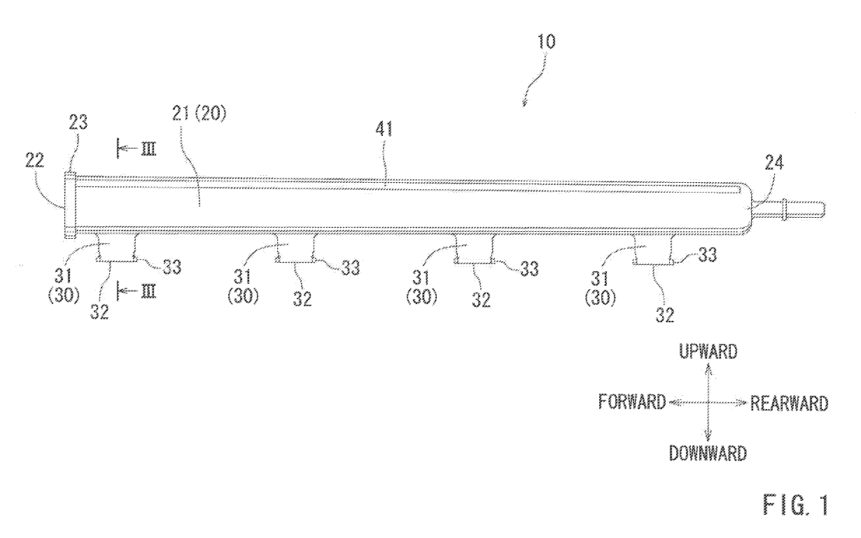

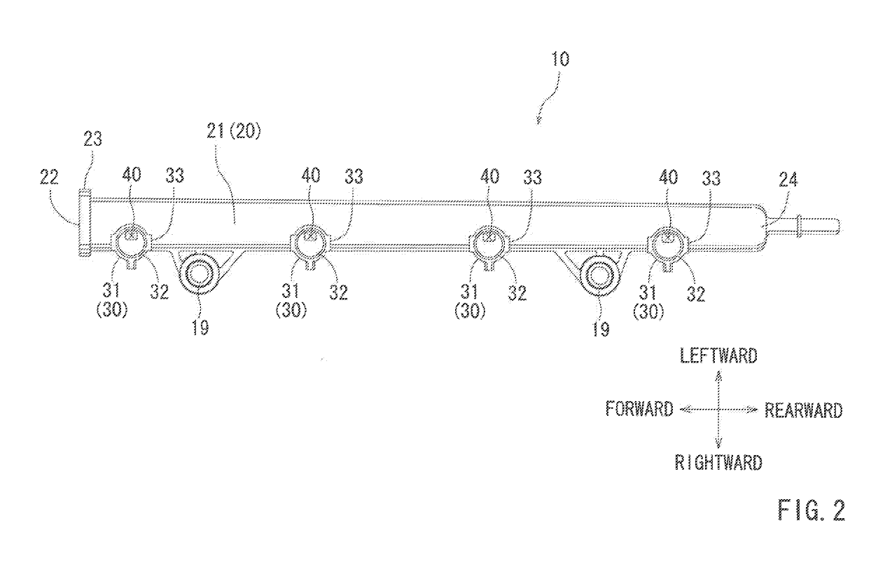

In the following, a fuel delivery pipe according to an embodiment of the present invention will be described with reference to the drawings. To facilitate the understanding of the description, the upper, lower, front, rear, right, and left sides as referred to in the description will be defined as those of a fuel delivery pipe 10 as shown in FIGS. 1 and 2.

The fuel delivery pipe 10 shown in FIGS. 1 through 3 is of a structure suited for use with a four-cylinder internal combustion engine (not shown). That is, the fuel delivery pipe 10 may include an elongated main pipe portion 20, and four distribution pipe portions 30 extending so as to intersect with the main pipe portion 20. The main pipe portion 20 may be a pipe portion through which fuel is supplied from a fuel tank (not shown) for storing fuel. The distribution pipe portions 30 may be pipe portions through which the fuel is supplied to the engine cylinders from the main pipe portion 20. An injector (not shown) may be mounted to each distribution pipe portion 30 to correspond to each engine cylinder. The fuel delivery pipe 10 may be a resin molded product having the main pipe portion 20 and the distribution pipe portions 30 integrated together.

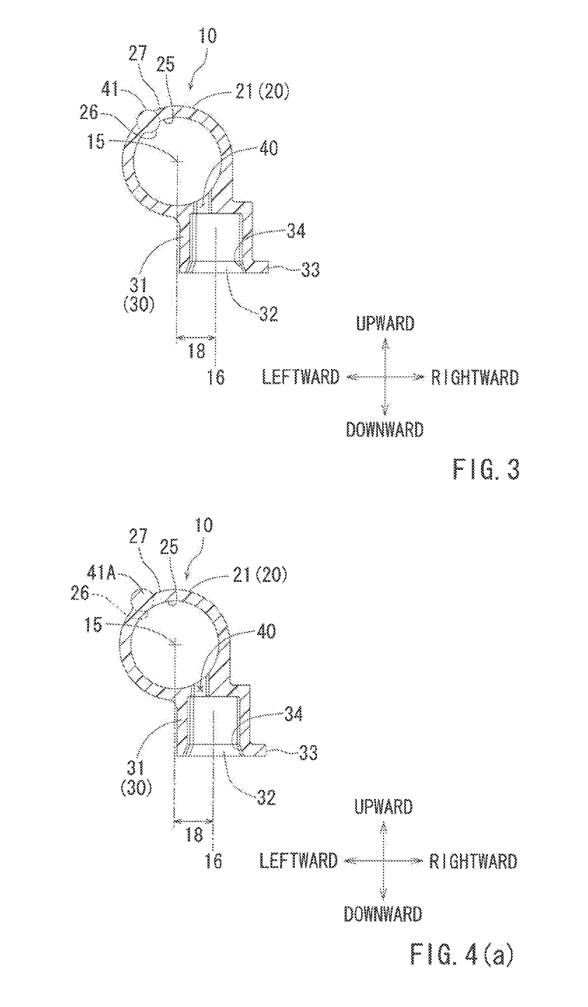

The fuel delivery pipe 10 may be formed through an integral molding process of a pipe main body 21 having the main pipe portion 20 and distribution pipe portions 31 as/or the distribution pipe portions 30. As shown in FIGS. 1 through 3, the pipe main body 21 as well as the main pipe portion 20 may be formed in a substantially tubular configuration with a bottom at the rear side. A pipe opening 22 is provided at the front end of the pipe main body 21. The pipe opening 22 may allow communication between the interior and the exterior of the substantially tubular pipe main body 21. A flange portion 23 may be formed at the end edge of the pipe opening 22. At the rear end of the pipe main body 21, there is provided a closed pipe dead end 24. The distribution pipe portions 31 and/or the distribution pipe portions 30 may protrude downwardly from the pipe main body 21 and/or the main pipe portion 20. The four distribution pipe portions 31 may be provided at equal intervals along the length of the pipe main body 21. The injector (not shown) may be mounted to the lower end of each distribution pipe portion 31. More specifically, at the lower end of each distribution pipe portion 31, there is provided a mounting port 32 which is open so as to allow communication between the interior and the exterior of the distribution pipe portion 31. As shown in FIG. 3, at the end edge of each mounting port 32, there may be provided a mounting protrusion 33 and a mounting tapered portion 34.

As shown in FIGS. 2 and 3, each of the main pipe portions 20 and the distribution pipe portions 30 may be formed to have a substantially circular cross-section. Regarding the main pipe portion 20, the central axis extending along the extending direction of the pipe main body 21 through the center of the substantially circular section of the main pipe portion 20 will be hereinafter referred to as a first central axis 15. Regarding each distribution pipe portion 30, the central axis extending in the extending direction of the distribution pipe portion 31 through the center of the substantially circular section of the distribution pipe portion 30 will be hereinafter referred to as a second central axis 16. As shown in FIG. 3, the first central axis 15 and each second central axis 16 are offset from each other by a distance 18. In FIG. 1, the first central axis 15 and each second central axis 16 are preferably orthogonal to each other. More specifically, in FIG. 2, the first central axis 15 extends orthogonal to each second central axis 16 while being offset therefrom to the left.

The main pipe portion 20 preferably communicates with the distribution pipe portions 30 via communication holes 40 shown in FIGS. 2 and 3. The size of the opening of each communication hole 40 is set to be smaller than the inner diameter of the distribution pipe portion 30. That is, the central axis of each communication hole 40 is offset to the right from the first central axis 15 and is offset to the left from the second central axis 16. In this way, the main pipe portion 20 having the pipe main body 21 and the distribution pipe portions 30 having the distribution pipe portions 31 are configured to allow fuel to flow from the main pipe portion 20 to the distribution pipe portions 30 via the communication holes 40 provided as described above.

Further, the pipe main body 21 may have externally protruding mounting support portions 19 with support holes for mounting the pipe main body 21 to the internal combustion engine (not shown).

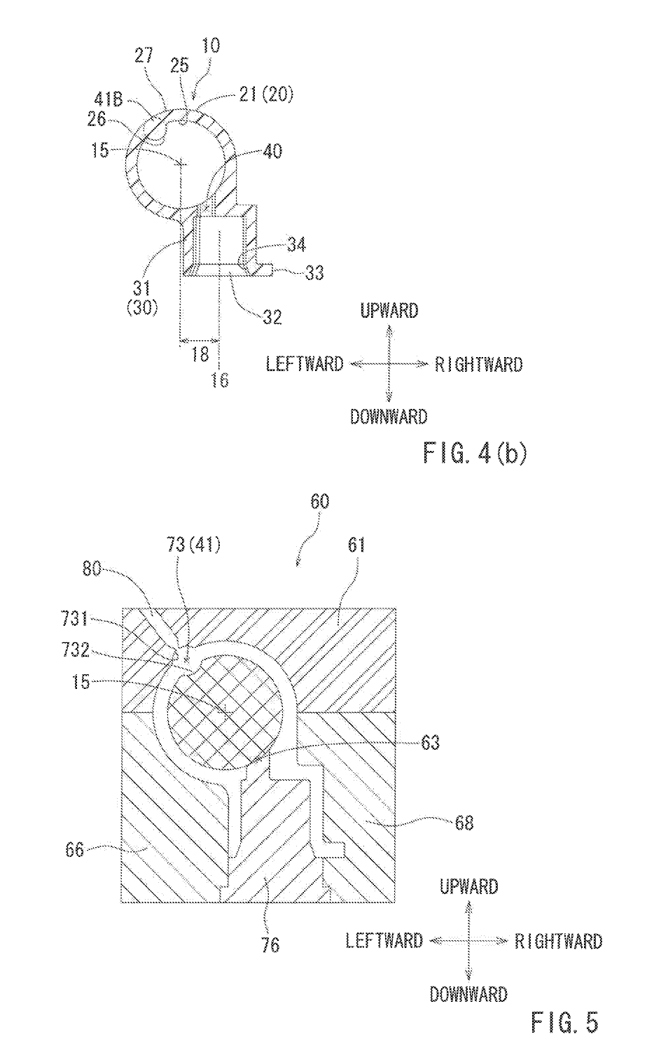

The pipe main body 21 having the main pipe portion 20 may have a rib forming portion 41. As shown in FIG. 1, the rib forming portion 41 is formed so as to extend straight along the extending direction of the main pipe portion 20. As shown in FIG. 3, the rib forming portion 41 may include an inner peripheral side portion 26 formed in series therewith across the main pipe portion 20. The inner peripheral side portion 26 may be positioned in point symmetry. This point symmetry can be with respect to the first central axis 15 and/or with the communication holes 40 communicating with the distribution pipe portions 30. That is, the rib forming portion 41 extends along an inner peripheral surface 25 of the main pipe portion 20 so as to include the inner peripheral portion 26 positioned in point symmetry with the respective communication holes 40 of the four distribution pipe portions 30. As shown in FIG. 3, the rib forming portion 41 may have a circular sectional configuration. As compared with the pipe main body 21 having the main pipe portion 20, the rib forming portion 41 may be larger in wall thickness. More specifically, the rib forming portion 41 may have a circular sectional configuration and may form ribs or linear projections protruding from both the inner peripheral surface 25 and the outer peripheral surface 27 of the pipe main body 21, whereby it exhibits a larger wall thickness than the pipe main body 21. In this way, the sectional area per unit arcuate range of the rib forming portion 41 about the first central axis 15 may be larger than that of the other portion of the pipe main body 21. In order to set the sectional area per unit arcuate range of the rib forming portion 41 to be larger than that of the other portion of the pipe main body 21, it is not necessary that the rib forming portion 41 has a circular sectional configuration. Instead, the rib forming portion 41 may have any other sectional configuration. With the configuration of the rib forming portion 41 selected to meet this condition, the rib forming portion 41 may form a rib(s) protruding either from one or both of the inner peripheral surface 25 and the outer peripheral surface 27 of the pipe main body 25. Here, the amount by which the rib forming portion 41 protrudes from the inner peripheral surface 25 may be set so as to secure the easiness with which the fuel existing in the pipe main body 21 is allowed to flow. The amount by which the rib of the rib forming portion 41 protrudes from the outer peripheral surface 27 may be set taking into account the installation space where the fuel delivery pipe 10 is installed. FIGS. 4(a) and 4(b) are sectional views illustrating modified rib forming portions 41A and 41B which are different from that of the rib forming portion 41 shown in the sectional view of FIG. 3. As compared with the rib forming portion 41 shown in FIG. 3, the rib forming portion 41A shown in FIG. 4(a) is shifted radially outwards. In contrast, the rib forming portion 41B shown in FIG. 4(b) is shifted radially inwards. Also in the case of the rib forming portion 41A or the rib forming portion 41B, it is possible to attain substantially the same effect as that of the rib forming portion 41 shown in FIG. 3. In addition, the rib forming portion 41A of FIG. 4(a) is advantageous in that it helps to secure the easiness with which the fuel existing in the pipe main body 21 is allowed to flow. The rib forming portion 41B of FIG. 4(b) is advantageous from the viewpoint of the installation space where the fuel delivery pipe 10 is installed.

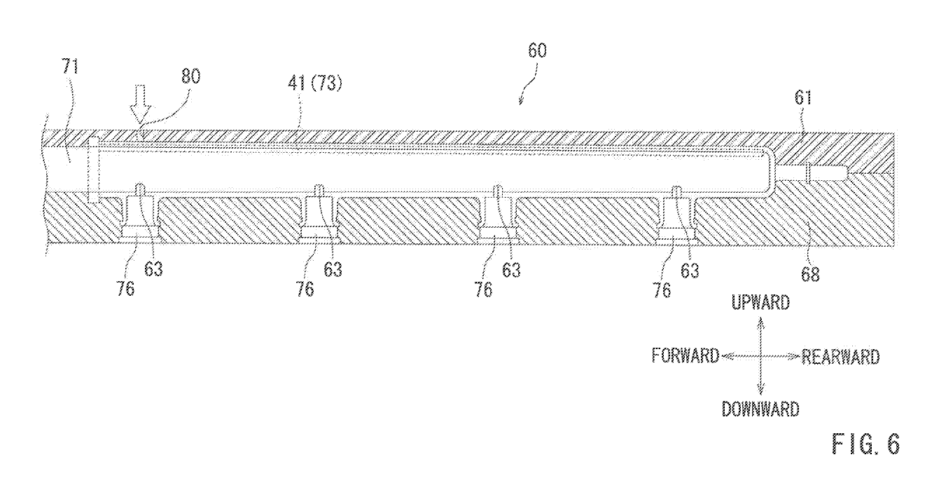

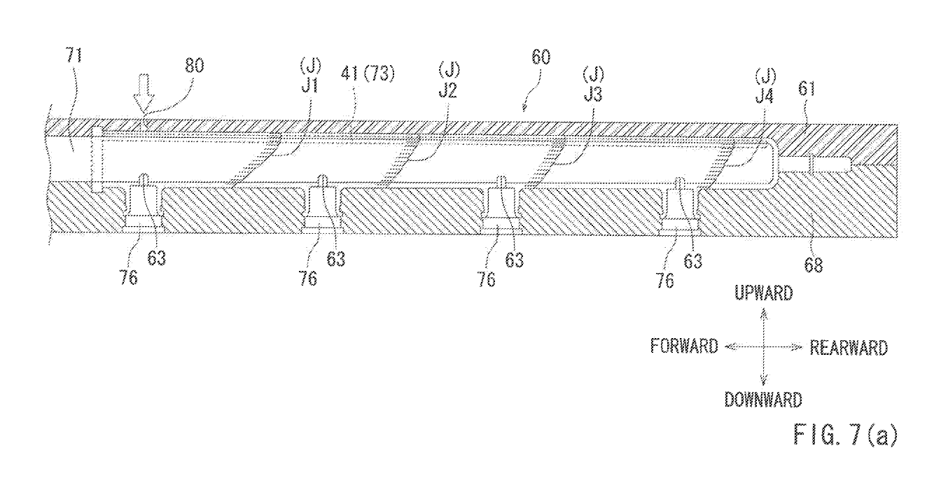

Next, a method of manufacturing the above-described fuel delivery pipe 10 will be described. The following description of the method of manufacturing the fuel delivery pipe 10 will be focused on a molding process using a mold during manufacturing of the fuel delivery pipe 10. FIG. 5 is a sectional view, corresponding to FIG. 3, of a mold 60 for molding the delivery pipe 10. FIG. 6 is a sectional view, corresponding to FIG. 1, of the mold 60 for molding the delivery pipe 10.

In FIG. 5, numeral 61 indicates a first outer mold, numeral 66 indicates a second outer mold, and numeral 68 indicates a third outer mold. Numeral 71 indicates a main pipe portion core, and numeral 76 indicates distribution pipe portion cores. The first outer mold 61 and the main pipe portion core 71 may serve as mold parts for molding the main pipe portion 20. On the other hand, the second outer mold 66, the third outer mold 68, and the distribution pipe portion cores 76 may serve as mold parts for mainly molding the distribution pipe portions 30. The regions where the main pipe portion core 71 contacts the distribution pipe portion cores 76 may serve as communication hole forming regions 63 for forming the communication holes 40. That is, the communication hole forming regions 63 are set as the regions where the main pipe portion core 71 contacts the distribution pipe portion cores 76.

The central axis extending along the extending direction of the main pipe portion core 71 may coincide with the first central axis 15 of the main pipe portion 20 described above. That is, the first central axis 15 coincides with the central axis extending along the extending direction of the pipe main body 21, and, at the same time, coincides with the central axis extending along the extending direction of the main pipe portion core 71. Here, a flow promoting space 73 is defined between the first outer mold 61 and the main pipe portion core 71 to facilitate the flow of the molten resin. The flow promoting space 73 may serve to form the above-described rib forming portion 41.

The above-mentioned rib forming portion 41 protrudes from both the inner peripheral surface 25 and the outer peripheral surface 27 of the pipe main body 21. In other words, the rib forming portion 41 forms ribs both on the inner peripheral surface 25 and the outer peripheral surface 27. Therefore, the flow promoting space 73 may include a first semi-circular recess 731 formed in the main pipe portion core 71 and a second semi-circular recess 732 formed in the first outer mold 61. Thus, the flow promoting space 73 is a part of the mold cavity of the mold 60 for molding the rib forming portion 41. Therefore, the flow promoting space 73 (731, 732) is defined between the main pipe portion core 71 and the first outer mold 61 of the mold 60 in point symmetry with the communication hole forming regions 63 with respect to the first central axis 15 of the main pipe portion 20. As shown in FIG. 6, the communication hole forming regions 63 are respectively provided at the four distribution pipe portion cores 76 corresponding to the four distribution pipe portions 30. Thus, the flow promoting space 73 (731, 732) is formed so as to over these four regions.

The rib forming portion 41 formed by the first semi-circular recess 731 and the second semi-circular recess 732 may have a larger wall thickness than the other portion of the pipe main body 21. That is, the sectional area per unit arcuate range of the flow promoting space 73 formed by the first semi-circular recess 731 and the second semi-circular recess 732 may be larger than that of the other portion of the pipe main body 21 than the rib forming portion 41. Therefore, during the molding of the rib forming portion 41 as described above, the flow promoting space 73 serves to facilitate the flow of the molten resin.

Further, for molding of the fuel delivery pipe 10 by using this mold 60, there is provided inside the mold 60 a resin injection port 80 for injection of the molten resin. As shown in FIG. 6, this resin injection port 80 may be formed in the first outer mold 61 in direct communication with the flow promoting space 73. As shown in FIG. 5, the resin injection port 80 may be directed toward the first central axis 15. Further, the resin injection port 80 may be arranged so as to be situated in the vicinity of the pipe opening 22 of the fuel delivery pipe 10 where the main pipe portion core 71 is supported.

In the fuel delivery pipe 10 described above, the distribution pipe portions 30 are arranged so as to have the second central axes 16 that are offset from the first central axis 15 of the main pipe portion 20 by the distance 18. This is required so that the fuel delivery pipe 10 can be installed for an internal combustion engine requiring such piping arrangement. Because the rib forming portion 41 forms the rib protruding from the inner peripheral surface of the main pipe portion 20, the molten resin for molding the fuel delivery pipe 10 can smoothly flow along the molding space provided for molding the rib forming portion 41. That is, the rib forming portion 41 has the effect of facilitating the flow of the molten resin. Because the molten resin can flow along the molding space for the rib forming portion 41, the mold for molding the main pipe portion 20 (main pipe portion core 71) may be pressed against the mold for molding the distribution pipe portions 30 (distribution pipe portion cores 76) by the pressure of the molten resin. That is, it is possible to enhance the abutment force between the main pipe portion core 71 and the distribution pipe portion cores 76 situated on the side opposite the rib forming portion 41 with respect to the main pipe portion core 71. Thus, it is possible to enhance the closeness in contact between the main pipe portion core 71 and the distribution pipe portion cores 76. This results in a possible inhibition of the molten resin to enter between them. This can thereby suppress the generation of burrs of the molding resin at the communication holes 40 that allows communication between the main pipe portion 20 and the distribution pipe portions 30.

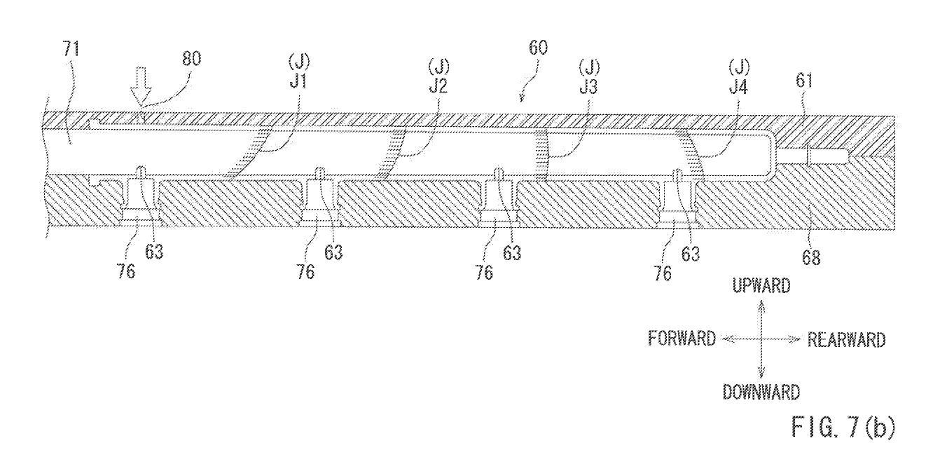

FIG. 7(a) illustrates how the molten resin J flows in the mold 60 shown in FIG. 6. FIG. 7(b) illustrates, as a comparative example to FIG. 7(a), how the molten resin J flows in a mold 60 according to the related art. That is, according to the above-described method of manufacturing the fuel delivery pipe 10, the flow promoting space 73 is provided at the position of the mold 60 in point symmetry. This point symmetry applies with respect to the first central axis 15, and/or each of the communication hole forming regions 63 where the main pipe portion core 71 and the distribution pipe portion cores 76 are in contact with each other. As shown in FIG. 7(a), the flow promoting space 73 is formed so as to connect these portions of the mold 60 with each other. In this way, the fluidity of the molten resin J flowing through these portions is enhanced. As a result, as can be seen from comparison between FIGS. 7(a) and 7(b), the injected molten resin J may preferentially flow through the flow promoting space 73 as compared with the other portions in the order of J1, J2, J3, and J4. The injected molten resin J preferentially flowing through the flow promoting space 73 may press the main pipe portion core 71 against the distribution pipe portion cores 76. That is, the main pipe portion core 71 and the distribution pipe portion cores 76 are forced to contact each other on the side opposite the flow promoting portion space 73 with respect to the main pipe portion core 71. Hence, it is possible to enhance the abutment force with which cores 71 and 76 contact each other. Accordingly, it is possible to enhance the closeness in contact between the main pipe portion core 71 and the distribution pipe portion cores 76, whereby it is possible to inhibit the molten resin J to enter between them. As a result, it possible to minimize the generation of burrs of the molten resin J at the communication holes 40 where the main pipe portion 20 and the distribution pipe portions 30 communicate with each other.

Further, according to the above-described method of manufacturing the fuel delivery pipe 10, the resin injection port 80 for injecting the molten resin J into the mold 60 is disposed to directly communicate with the flow promoting space 73 provided in the mold 60, so that the injected molten resin J can flow preferentially easily into the flow promoting space 73. Further, according to the above-described method of manufacturing the fuel delivery pipe 10, the resin injection port 80 is directed towards the first central axis 15. In this way it is possible to press the main pipe portion core 71 against the distribution pipe portion cores 76 by utilizing the pressure of the molten resin J injected from the resin injection port 80. As a result, it is possible to increase the pressing force applied to the main pipe portion core 71 in a direction toward the distribution pipe portion cores 76, making it possible to effectively enhance the abutment force between the cores 71 and 76. Further, according to the above-described method of manufacturing the fuel delivery pipe 10, the resin injection port 80 is arranged at a position proximal to the pipe opening 22 where the main pipe portion core 71 is supported. The main pipe portion core 71 may be supported by a clamp mechanism (not shown) provided only on one side of it. That is to say that it is supported in a so-called cantilever fashion. The clamp mechanism for supporting the main pipe portion core in a cantilever fashion may be positioned in the vicinity of the pipe opening 22 of the main pipe portion 20 communicating with the exterior.

Thus, as compared with the arrangement of the clamp mechanism on the side of the closed pipe dead end 24 of the main pipe portion core 71, the arrangement on the side of the pipe opening 22 can more securely support the main pipe portion core 71. Therefore, although the main pipe portion core 71 may receive the injection pressure of the molten resin J injected from the resin injection port 80, it is possible to efficiently suppress the shifting movement of the main pipe portion core 71 since the main pipe portion core 71 is supported more securely.

The above embodiment may be modified in various ways. For example, the configurations of the above-described rib forming portions 41, 41A, and 41B may not be limited to those shown in the drawings. Any other configuration may be used as long as the rib forming portion extends along the extending direction of the main pipe portion while including the inner peripheral portion of the main pipe portion in point symmetry with the communication regions with respect to the first central axis. The sectional configurations of the rib forming portions may not be limited to the circular configuration but may be, for example, elliptical, triangular, and rectangular configurations. Further, the rib forming portion may form a rib or a projection on “at least one of the inner peripheral surface and the outer peripheral surface of the main pipe portion.” That is, the rib forming portion may form a rib or a projection on “the inner peripheral surface of the main pipe portion,” on “the outer peripheral surface of the main pipe portion,” or on “both the inner and outer peripheral surfaces of the main pipe portion.”

Further, the flow promoting space may be formed in correspondence with the configuration of the rib forming portion, and it is not limited to have the first semi-circular recess 731 and the second semi-circular recess 732 of the above-described embodiment. When, as in the above-described embodiment, the flow promoting space 73 (rib forming portion 41) is formed in a circular sectional configuration (the first semi-circular recess 731 and the second semi-circular recess 732), the molten resin J may easily flow to cover the entire sectional range of the rib forming portion 41. That is, it is possible to form the flow promoting space 73 (rib forming portion 41) as small as possible while making it also possible to preferably inject the molten resin J into the flow promoting space 73.

What is claimed is:

1. A fuel delivery pipe comprising:
a main pipe portion configured to receive a supply of fuel from a fuel storage device; and
a plurality of distribution pipe portions communicating with the main pipe portion via respective communication holes and configured to distribute fuel from the main pipe portion to respective engine cylinders; wherein
the main pipe portion and the plurality of distribution pipe portions are made of resin and are integrated together;
the main pipe portion has a first central axis and extends along the first central axis;
each of the distribution pipe portions has a second central axis and extends along the second central axis;
each of the distribution pipe portions intersects with the main pipe portion, while the second central axis of each of the distribution pipe portions being offset from the first central axis of the main pipe portion;
the main pipe portion includes a rib forming portion including a rib projecting from at least one of an inner peripheral surface or an outer peripheral surface of the main pipe portion and extending along an extending direction of the main pipe portion; and
the rib forming portion further includes an inner peripheral portion disposed at the inner peripheral surface of the main pipe portion at a position in point symmetry, with respect to the first central axis, with the communication holes.

2. The fuel delivery pipe according to claim 1, wherein the rib of the rib forming portion includes a first rib and a second rib, the first rib projects inward from the inner peripheral surface of the main pipe portion, and the second rib projects outward from the outer peripheral surface of the main pipe portion.

3. The fuel delivery pipe according to claim 1, wherein the rib of the rib forming portion projects outward from the outer peripheral surface of the main pipe portion.

4. The fuel delivery pipe according to claim 1, wherein the rib of the rib forming portion projects inward from the inner peripheral surface of the main pipe portion.

5. The fuel delivery pipe according to claim 1, wherein the second central axes of the distribution pipe portions extend parallel to each other and perpendicular to the first central axis, so that the second central axes are offset by a given distance from the first central axis.

6. The fuel delivery pipe according to claim 1, wherein each of the communication holes is offset from both of the first central axis and the second central axis of the corresponding distribution pipe portion.

7. A method of manufacturing a fuel delivery pipe including a main pipe portion configured to receive a supply of fuel from a fuel storage device, and a plurality of distribution pipe portions communicating with the main pipe portion via respective communication holes and configured to distribute fuel from the main pipe portion to respective engine cylinders, the main pipe portion and the plurality of distribution pipe portions being made of resin and integrated together, the main pipe portion having a first central axis and extending along the first central axis, each of the distribution pipe portions having a second central axis and extending along the second central axis, and each of the distribution pipe portions intersecting with the main pipe portion, while the second central axis of each of the distribution pipe portions being offset from the first central axis of the main pipe portion, the method comprising:
providing a mold including a main pipe portion core and a plurality of distribution pipe portion cores, the main pipe portion core being used for molding the main pipe portion, the distribution pipe portion cores being used for molding the distribution pipe portions, the distribution pipe portion cores contacting the main pipe portion core at contact regions, where the communication holes are molded;
providing a flow promoting space within the mold at a position in point symmetry, with respect to the first central axis, with the communication holes for facilitating flow of a molten resin into the flow promoting space; and
injecting a molten resin into the mold to form the fuel delivery pipe having the main pipe portion and the distribution pipe portions integrated with the main pipe portion.

8. The method according to claim 7, wherein the mold further includes a resin injection port, through which a molten resin is injected into the mold, and the resin injection port is opened at the flow promoting space of the mold.

9. The method according to claim 8, wherein the resin injection port is directed toward the first central axis.

10. The method according to claim 7, wherein the mold further includes a resin injection port, through which a molten resin is injected into the mold, and the resin injection port is disposed proximal to a part of the mold for forming an opening of the fuel delivery pipe, where the main pipe portion core is supported.

11. A method of manufacturing a fuel delivery pipe, comprising:
providing a mold for molding the fuel delivery pipe, the mold including a main pipe portion core and a plurality of distribution pipe portion cores, the main pipe portion core being used for molding a main pipe portion of the fuel delivery pipe, the distribution pipe portion cores being used for molding a plurality of distribution pipe portions of the fuel delivery pipe, the distribution pipe portion cores contacting the main pipe portion core at contact regions, where communication holes for communication between the main pipe portion and the distribution pipe portions are molded; and
injecting a molten resin into the mold, so that a pressure of the molten resin is applied to the main pipe portion core to press the main pipe portion core against the distribution pipe portion cores at the contact regions.

12. The method according to claim 11, wherein the pressure of the molten resin is applied to the main pipe portion core in a direction towards the contact regions passing through a central axis of the main pipe portion.
